(19) United States
(12) Patent Application Publication
(10) Pub. No.: US 2026/0368041 A1
(43) Pub. Date: Nov. 19, 2026

(54) DATABASE BATCH JOB ROLLBACK

(71) Applicant: International Business Machines Corporation, Armonk, NY (US)

(72) Inventors: Li Fei Zheng, Shanghai (CN); Min Fang, Beijing (CN); Di Jin, Beijing (CN); Yun Jie Fang, Beijing (CN); Jun Wan, Beijing (CN); Ye Wang, Shanghai (CN)

(21) Appl. No.: 19/207,556

(22) Filed: May 14, 2025

(51) Int. Cl. G06F 11/1446

(52) U.S. Cl. CPC G06F 11/1469

(57) ABSTRACT

Examples described herein provide a computer-implemented method that includes receiving a batch job to be executed on a database of a computer system. The method further includes recording a beginning image of the database prior to executing the batch job. The method further includes initiating executing the batch job. The method further includes responsive to encountering an error while executing the batch job, initiating a rollback for the database based at least in part on the beginning image of the database.

### BACKGROUND

The present disclosure relates to computing environments, and more specifically, to database batch job rollback.

Database batch jobs are automated tasks that perform large-scale operations on a database, typically outside of real-time user interaction. These jobs are designed to run at scheduled intervals—such as nightly or weekly—or be triggered by specific events. Batch jobs are commonly used for tasks like data extraction, transformation, and loading (ETL), report generation, data archiving, cleanup operations, and billing processes. Because batch jobs often handle substantial amounts of data, they are usually scheduled during off-peak hours to minimize their impact on system performance. Once configured, batch jobs run without manual intervention, making them a reliable and repeatable way to maintain and manage data workflows.

### SUMMARY

According to an embodiment, a computer-implemented method for database batch job rollback is provided. The method includes receiving a batch job to be executed on a database of a computer system. The method further includes recording a beginning image of the database prior to executing the batch job. The method further includes initiating executing the batch job. The method further includes responsive to encountering an error while executing the batch job, initiating a rollback for the database based at least in part on the beginning image of the database.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment according to one or more embodiments;

FIG. 2 illustrates a flow diagram of a method for database batch job rollback according to one or more embodiments;

FIG. 3A illustrates a diagram comparing an existing rollback approach to the rollback approach described herein according to one or more embodiments; and

FIG. 3B illustrates a diagram comparing an existing rollback approach to the rollback approach described herein according to one or more embodiments.

### DETAILED DESCRIPTION

One or more embodiments described herein provide for database batch job rollback.

According to an embodiment, a computer-implemented method includes receiving a batch job to be executed on a database of a computer system. The method further includes recording a beginning image of the database prior to executing the batch job. The method further includes initiating executing the batch job. The method further includes, responsive to encountering an error while executing the batch job, initiating a rollback for the database based at least in part on the beginning image of the database. Such a method provides for the reduction in time for performing the rollback process, which minimizes the duration of data unavailability/outages for related objects. By recording a “beginning image” of the database page before any changes are made, one or more embodiments can revert the database to its original state in a single operation if an error occurs, rather than undoing each change individually. This approach not only speeds up the recovery process but also reduces the processing resources used for performing rollback, thereby improving overall computer system performance.

According to an embodiment, the beginning image is an image of a page of the database. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, recording the beginning image of the database is triggered responsive to a page of the database being latched. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, the rollback reverts the database to a state at a time the beginning image of the database was recorded without undoing individual tasks of the batch job on a task-by-task basis. This improvement in efficiency in handling rollbacks also contributes to improved system throughput, as it allows other transactions to proceed without being delayed by lengthy recovery processes.

According to an embodiment, the method further includes tracking statistics about the batch job and other batch jobs to determine which batch jobs are suitable for recording the beginning image and initiating the rollback based at least in part on the beginning image. Such an embodiment improves database system efficiency by dynamically optimizing rollback processes through the use of tracked batch job statistics to identify suitable candidates for recording beginning images and initiating rollbacks.

According to an embodiment, the recording the beginning image and the initiating the rollback based at least in part on the beginning image are disabled based on a number of consecutive lock requests against a same page of the database exceeding a threshold as determined by the statistics about the batch job and other batch jobs.

According to an embodiment, the method further includes, responsive to not encountering an error while executing the batch job, continuing to execute the batch job until the batch job is completed. Such an embodiment enhances system reliability and efficiency by ensuring uninterrupted execution of batch jobs when no errors are encountered, thereby avoiding unnecessary rollbacks.

According to an embodiment, the method further includes, subsequent to completing the batch job, deleting the beginning image of the database. Such an embodiment optimizes resource utilization by removing unnecessary data through the deletion of the beginning image of the database after successful completion of the batch job.

According to an embodiment, a computer system includes a processor set, one or more computer-readable storage media, and program instructions stored on the one or more computer-readable storage media to cause the processor set to perform operations. The operations include receiving a batch job to be executed on a database of a computer system. The operations further include recording a beginning image of the database prior to executing the batch job. The operations further include initiating executing the batch job. The operations further include, responsive to encountering an error while executing the batch job, initiating a rollback for the database based at least in part on the beginning image of the database. Such a computer system provides for the reduction in time for performing the rollback process, which minimizes the duration of data unavailability/outages for related objects. By recording a “beginning image” of the database page before any changes are made, one or more embodiments can revert the database to its original state in a single operation if an error occurs, rather than undoing each change individually. This approach not only speeds up the recovery process but also reduces the processing resources used for performing rollback, thereby improving overall computer system performance.

According to an embodiment, the beginning image is an image of a page of the database. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, recording the beginning image of the database is triggered responsive to a page of the database being latched. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, the rollback reverts the database to a state at a time the beginning image of the database was recorded without undoing individual tasks of the batch job on a task-by-task basis. This improvement in efficiency in handling rollbacks also contributes to improved system throughput, as it allows other transactions to proceed without being delayed by lengthy recovery processes.

According to an embodiment, the operations further include tracking statistics about the batch job and other batch jobs to determine which batch jobs are suitable for recording the beginning image and initiating the rollback based at least in part on the beginning image. Such an embodiment improves database system efficiency by dynamically optimizing rollback processes through the use of tracked batch job statistics to identify suitable candidates for recording beginning images and initiating rollbacks.

According to an embodiment, the recording the beginning image and the initiating the rollback based at least in part on the beginning image are disabled based on a number of consecutive lock requests against a same page of the database exceeding a threshold as determined by the statistics about the batch job and other batch jobs.

According to an embodiment, the operations further include, responsive to not encountering an error while executing the batch job, continuing to execute the batch job until the batch job is completed. Such an embodiment enhances system reliability and efficiency by ensuring uninterrupted execution of batch jobs when no errors are encountered, thereby avoiding unnecessary rollbacks.

According to an embodiment, the operations further include, subsequent to completing the batch job, deleting the beginning image of the database. Such an embodiment optimizes resource utilization by removing unnecessary data through the deletion of the beginning image of the database after successful completion of the batch job.

According to an embodiment, a computer program product includes one or more computer-readable storage media, and program instructions stored on the one or more computer-readable storage media to perform operations. The operations include receiving a batch job to be executed on a database of a computer system. The operations further include recording a beginning image of the database prior to executing the batch job. The operations further include initiating executing the batch job. The operations further include, responsive to encountering an error while executing the batch job, initiating a rollback for the database based at least in part on the beginning image of the database. Such a computer program product provides for the reduction in time for performing the rollback process, which minimizes the duration of data unavailability/outages for related objects. By recording a “beginning image” of the database page before any changes are made, one or more embodiments can revert the database to its original state in a single operation if an error occurs, rather than undoing each change individually. This approach not only speeds up the recovery process but also reduces the processing resources used for performing rollback, thereby improving overall computer system performance.

According to an embodiment, the beginning image is an image of a page of the database. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, recording the beginning image of the database is triggered responsive to a page of the database being latched. Such an embodiment further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective.

According to an embodiment, the rollback reverts the database to a state at a time the beginning image of the database was recorded without undoing individual tasks of the batch job on a task-by-task basis. This improvement in efficiency in handling rollbacks also contributes to improved system throughput, as it allows other transactions to proceed without being delayed by lengthy recovery processes.

In modern computing environments, database batch jobs play a significant role in performing large-scale operations on databases. These jobs are typically executed outside of real-time user interaction and are scheduled at specific intervals or triggered by particular events. Common tasks for batch jobs include data extraction, transformation, and loading (ETL), report generation, data archiving, cleanup operations, and billing processes. Due to the substantial amount of data handled by these jobs, batch jobs are often scheduled during off-peak hours to minimize their impact on system performance. However, the execution of batch jobs can be disrupted by errors or failures encountered while executing the batch jobs, necessitating a rollback operation (or simply a “rollback”) to maintain data integrity.

The rollback operation in database systems is an operation that enables the system to revert the database to a previous consistent state in the event of a failure, deadlock, or explicit request by an application. From a database recovery perspective, the rollback operation often causes an outage for related pages when there are many records/logs involved, which is often the case for batch jobs. Existing rollback operations involve undoing changes individually, which can be time-consuming and resource-intensive, particularly when handling substantial volumes of data. This approach often results in extended outage times, during which the affected records are inaccessible to other processes or users. Such delays can greatly affect the overall performance and availability of the database system.

Existing approaches for handling rollbacks in database systems have several disadvantages. One significant drawback is the inefficiency of the rollback process when a large number of records or logs are involved. Such inefficiency is due to the rollback process implementing a task-by-task rollback or “undue” of each task having already been completed for a batch job. This approach of reversing each task individually for a batch job when an error is encountered can result in extended downtime, particularly for batch jobs that modify millions of records. Additionally, the locking mechanisms employed during rollbacks can lead to further complications. For instance, page-level locking, where an entire page is locked during a transaction, prevents other changes from being made, thereby exacerbating the unavailability of data. Similarly, row-level locking, which locks the specific row being updated, allows other rows on the page to be modified but requires a different approach to ensure data consistency.

One or more embodiments described herein addresses these challenges by introducing a rollback approach that improves performance of batch jobs. This technique significantly reduces the time required for the rollback process, thereby minimizing the outage duration for related objects and enhancing the overall computing system performance. One or more embodiments leverages a rollback approach that involves recording an original image of the database page before any changes are made (e.g., before execution of the batch job commences). In the event of an error being detected, the system can revert to this original image in a single operation, rather than undoing each change (task) of a batch job individually. This approach is particularly effective in scenarios involving page-level locking, where the entire page is locked during the transaction. By optimizing the rollback process, one or more embodiments described herein not only improves the efficiency of batch jobs but also enhances the high availability of database management systems, thereby improving their functionality.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

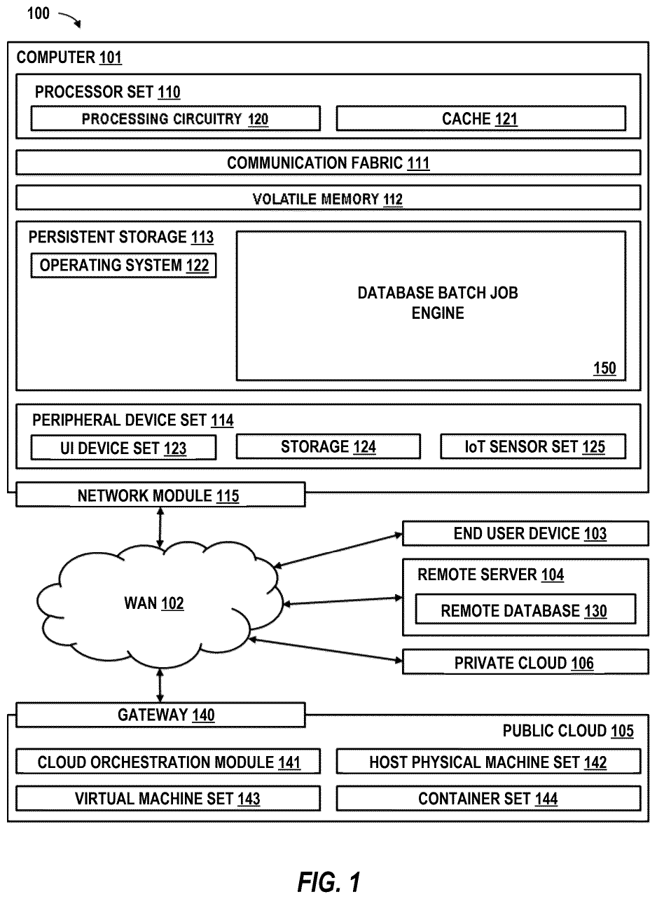

FIG. 1 illustrates a computing environment 100, according to an embodiment. Computing environment 100 contains an example of an environment for the execution of at least some of the computer code involved in performing the inventive methods, such as a database batch job engine 150 for managing namespace range-based memory device compaction. In addition to the database batch job engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the database batch job engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the database batch job engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the database batch job engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the database batch job engine 150 implements candidate batch job detection using a catalog table (e.g., “SYSFASTBACKOUT”). The catalog table is designed to identify batch jobs and associated objects that are suitable for fast recovery based on collected statistics. Users can add batch job names and object identifiers to this table, enabling the database batch job engine 150 to recognize which batch jobs will benefit from the rollback process described herein. The database batch job engine 150 dynamically adjusts the involvement of objects in the fast recovery process, providing for selecting those batch jobs that meet certain criteria. This approach allows for efficient management of batch jobs, optimizing the rollback process for those that handle substantial data changes and are prone to errors or failures.

According to one or more embodiments, the database batch job engine 150 implements page level locking (PLL) and/or row level locking (RLL) as part of the rollback process. For batch jobs that utilize PLL, a new type of log is introduced to record the “beginning image” of the database page as the UNDO log. Subsequent change logs for the batch job do not include the UNDO part, streamlining the rollback process. In the case of RLL, the “beginning image” UNDO log is recorded for each page touched by the batch job when the latch is first acquired, and a flag is set to indicate this. When the database sends a request for the next page or an online transaction interrupts, the previous page is unlatched, and the flag is turned off. This differentiation between PLL and RLL ensures that the rollback process is tailored to the specific locking granularity, enhancing efficiency and reducing downtime.

According to one or more embodiments, the database batch job engine 150 implements an index similar to the RLL process. Unlike data tables, indexes do not use logical locks for serialization; instead, they rely on index leaf page latches. The implementation for indexes follows the same principles as RLL, where the latch mechanism is used to manage changes. When an online transaction requests the latch for the same page, and the flag is on, a request is issued to the related batch job to unlatch the page, allowing the transaction to proceed. If another batch job requests the latch, the database batch job engine 150 compares a batch unit of recovery identifier (URID) and either makes the other batch wait or returns a reason code. This approach ensures that index changes are efficiently managed during the rollback process, maintaining data consistency and minimizing disruptions.

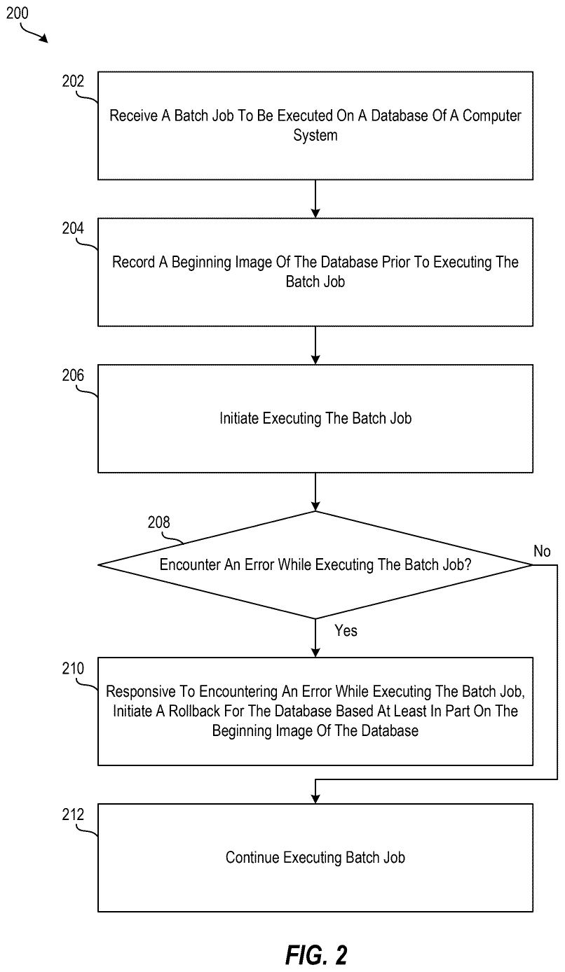

FIG. 2 illustrates a flow diagram of a method 200 for database batch job rollback according to one or more embodiments. The method 200 can be performed by any suitable computing system, device, or environment, such as those described herein. The method 200 is now described with reference to the computing environment 100, and particularly the database batch job engine 150, but is not so limited.

At operation 202, the database batch job engine 150 receives a batch job to be executed on a database of a computer system (e.g., the computing environment 100 of FIG. 1). The batch job may include various tasks, such as data extraction, transformation, and loading, which are scheduled to run at specific intervals or triggered by particular events.

Operation 204 involves the database batch job engine 150 recording a beginning image of the database prior to executing the batch job. This operation enables the rollback process, as the database batch job engine 150 captures the state of the database before any changes are made by the batch job. The beginning image serves as a reference point, allowing the database batch job engine 150 to revert to this state in the event of an error or failure during execution. By recording the beginning image, the database batch job engine 150 supports data integrity and provides a mechanism for efficient database recovery.

At operation 206, the database batch job engine 150 initiates executing the batch job. This operation involves the database batch job engine 150 starting the batch job and performing the tasks specified within it. The execution process is designed to be automated and run without manual intervention, allowing for reliable and repeatable data workflows. During this operation, the database batch job engine 150 monitors the batch job for any errors or failures that may occur, ensuring that the process runs smoothly and efficiently.

Operation 208 is a decision point where the database batch job engine 150 determines whether an error has been encountered while executing the batch job. If no error is detected, the method 200 continues to operation 212, where the batch job execution proceeds until completion (or until an error is detected).

However, if an error is encountered, the database batch job engine 150 moves to operation 210, where a rollback is initiated for the database based on the beginning image recorded earlier. Particularly, in operation 210, the database batch job engine 150 initiates a rollback for the database in response to encountering an error during batch job execution. The rollback process leverages the beginning image recorded in operation 204, allowing the database batch job engine 150 to revert the database to the previous consistent state in a single operation. That is, the rollback process reverts the database to a state at a time the beginning image of the database was recorded without undoing individual tasks of the batch job on a task-by-task basis. This approach minimizes the time and resources required for recovery, reducing outage duration and enhancing overall system performance. By optimizing the rollback process, the system ensures high availability and functionality of the database management system.

Finally, operation 212 involves continuing the execution of the batch job if no error is encountered during the process. This operation ensures that the batch job continues executing until completing successfully, with the tasks of the batch job being performed as intended. Once the batch job is completed, the database batch job engine 150 may delete the beginning image of the database, as it is no longer needed for rollback purposes. This operation marks the end of the method 200, with the database batch job engine 150 ready to receive and execute subsequent batch jobs.

The method 200 can be used to perform page level locking and/or row level locking. In PLL, the beginning image is an image of a page of the database, while in RLL, recording the beginning image of the database is triggered responsive to a page of the database being latched. PLL and RLL are now described in more detail.

PLL is a database locking mechanism that locks an entire page of data during a transaction (e.g., a batch job). This approach is used to ensure data consistency and integrity when multiple transactions are accessing the same data. In PLL, when a transaction modifies data on a page, the entire page is locked, preventing other transactions from making changes to any data on that page until the lock is released. This approach is particularly useful in scenarios where transactions need to access large amounts of data simultaneously, as it reduces the overhead associated with managing multiple locks on individual rows. However, PLL can lead to increased contention and reduced concurrency, as other transactions must wait for the lock to be released before accessing the page.

In the context of improving rollback performance for batch jobs using PLL, when a batch job is executed, the batch job may involve modifications to numerous pages within the database. By implementing PLL, the database batch job engine 150 can efficiently manage these modifications by locking entire pages rather than individual rows. This approach simplifies the rollback process, as the database batch job engine 150 reverts changes at the page level rather than tracking and undoing each individual modification. By recording the “beginning image” of the page as an UNDO log before any changes are made, the database batch job engine 150 can quickly restore the page to its original state in the event of an error, significantly reducing the time and resources required for rollback.

An example implementation of PLL in a database system could involve a batch job that updates customer records in a large database. Suppose the batch job desires to update the addresses of customers stored on several pages. Before the batch job begins, the database batch job engine 150 records a “beginning image” of each page involved in the transaction. As the batch job proceeds, the database batch job engine 150 locks each page to be accessed, preventing other transactions from modifying the data on those pages. If an error occurs during the batch job, the database batch job engine 150 can quickly revert each page to its “beginning image” using the recorded UNDO logs, effectively rolling back the changes in a single operation. Once the rollback is complete, the locks to the pages are released, allowing other transactions to access the pages. This implementation demonstrates how PLL can enhance the efficiency and reliability of batch job rollbacks by minimizing the complexity and duration of the recovery process.

RLL is a database locking mechanism that locks individual rows within a page during a transaction. This approach allows for greater concurrency compared to PLL, as RLL enables multiple transactions to access different rows on the same page simultaneously. RLL is particularly beneficial in environments where transactions frequently update or query specific rows, as RLL minimizes the contention and waiting time associated with locking entire pages. By locking the rows being modified (without locking rows not being modified), RLL allows other transactions to proceed with operations on unaffected rows, thereby improving overall system performance and throughput.

In the context of enhancing rollback performance for batch jobs, RLL provides a more granular approach to managing data modifications. When a batch job is executed, the batch job may involve changes to numerous rows across various pages in the database. By implementing RLL, the database batch job engine 150 can efficiently manage these changes by locking the rows involved in the transaction while leaving other rows unlocked. This approach simplifies the rollback process, as the database batch job engine 150 can focus on reverting changes at the row level rather than dealing with entire pages. By recording the “beginning image” UNDO log for each row touched by the batch job when the latch is first acquired, the database batch job engine 150 can quickly restore the row to its original state in the event of an error, reducing the time and resources required for rollback.

An example implementation of RLL in a database system could involve a batch job that updates the inventory levels of products in a retail database. Suppose the batch job desires to adjust the stock quantities for specific products stored on several pages. Before the batch job begins, the system records a “beginning image” of each row involved in the transaction. The database batch job engine 150 writes the UNDO log when a latch of a page is first set, and sets a flag ON for the page. When the database batch job engine 150 receives a “getpage” request for a next page or a “break in” by an online transaction, the previous page is unlatched and the previous flag is turned OFF. That is, as the batch job proceeds, the database batch job engine 150 locks each row involved in the transaction, allowing other transactions to modify different rows on the same page. If an error occurs during the batch job, the database batch job engine 150 can quickly revert the respective rows to their “beginning image” using the recorded UNDO logs, effectively rolling back the changes at the row level. Once the rollback is complete, the locks are released, enabling other transactions to access the rows. This implementation demonstrates how RLL can enhance the efficiency and reliability of batch job rollbacks by minimizing the complexity and duration of the recovery process.

Consider the following example for RLL. At a first time T1, a latch for Page A is set, and the “beginning image” UNDO log is written for Page A. At a second time T2, Page A is unlatched and a latch for Page B is set along with writing the “beginning image” UNDO log for Page B. If a failure occurs after time T2, Page B is unlatched, and the database is reverted for Page A and Page B using the respective “beginning image” UNDO logs for Page A and Page B.

The database batch job engine 150 stores formatted latch information in memory. Based on those formats, one bit is used to indicate that there is a batch process taking the latch, e.g., “Latch.FlagforBatchGetLatch.” According to one or more embodiments, this process can be applied for indexes as the database does not take logical locks for indexes (but does so for latches). When there are online transactions that require the latch for the same page, if the flag is ON, the online transactions issue a request to the related batch so that batch will unlatch the page and allow the online transactions to break in. When there is another batch that requests the latch for the same page, by comparing the batch URID, the database batch job engine 150 lets that other batch wait or return a reason code. When the flag switches from ON to OFF, an UNDO image log is written for the corresponding recovery identifier for the rollback process.

With continued reference to FIG. 2, the method 200 may include additional operations in various embodiments. For example, the method 200 can include the database batch job engine 150 tracking statistics about the batch job and other batch jobs to determine which batch jobs are suitable for recording the beginning image and initiating the rollback based at least in part on the beginning image. Where such statistics are recorded, those statics can be used in the rollback process. For example, the recording the beginning image and the initiating the rollback based at least in part on the beginning image are disabled based on a number of consecutive lock requests against a same page of the database exceeding a threshold as determined by the statics about the batch job and other batch jobs.

Regarding the statistics, the database batch job engine 150 collects statistics including total insert/update/delete (I/U/D) activities, average number of records changed in a page in each commit interval for PLL, average number of record changed in the same page in a row for RLL, etc., about specific batch jobs. Based on the statistics, a user can insert a batch name and objects involved in the catalog table SYSFASTBACKOUT. Then, database batch job engine 150 enables a fast_backout flag when a batch job is running against those batch and objects listed in the catalog table. In the catalog table, the user can also specify if the fast_backout flag should always be effective or dynamically adjusted. For PLL, the dynamic adjustment is based on consecutive lock requests (e.g., X number of consecutive lock requests) against the same page. For RLL or index, the dynamic adjustments is based on consecutive latch requests (e.g., Y number of consecutive latch requests) against the same page. The database batch job engine 150 can detect usage of the related data pages and index pages and turn ON or turn OFF the batch rollback functionality dynamically. For example, if a threshold is set to five, the rollback process is enabled for a next interval. If there are two continuous intervals that have the number less than three, the rollback functionally is disabled. The following table provides various embodiments for dynamically enabling or disabling the rollback process:

| Interval | Counts of I/U/D on the Page | Batch Rollback Function |
|---|---|---|
| 1^{st} | 5 | OFF |
| 2^{nd} | 4 | ON |
| 3^{rd} | 10 | ON |
| 4^{th} | 1 | ON |
| 5^{th} | 1 | ON |
| 6^{th} | 1 | OFF |

It should be understood that the processes depicted in FIG. 2 represent illustrations, and that other processes may be added or existing processes may be removed, modified, or rearranged without departing from the scope of the present disclosure. It should also be understood that the processes depicted in FIG. 2 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

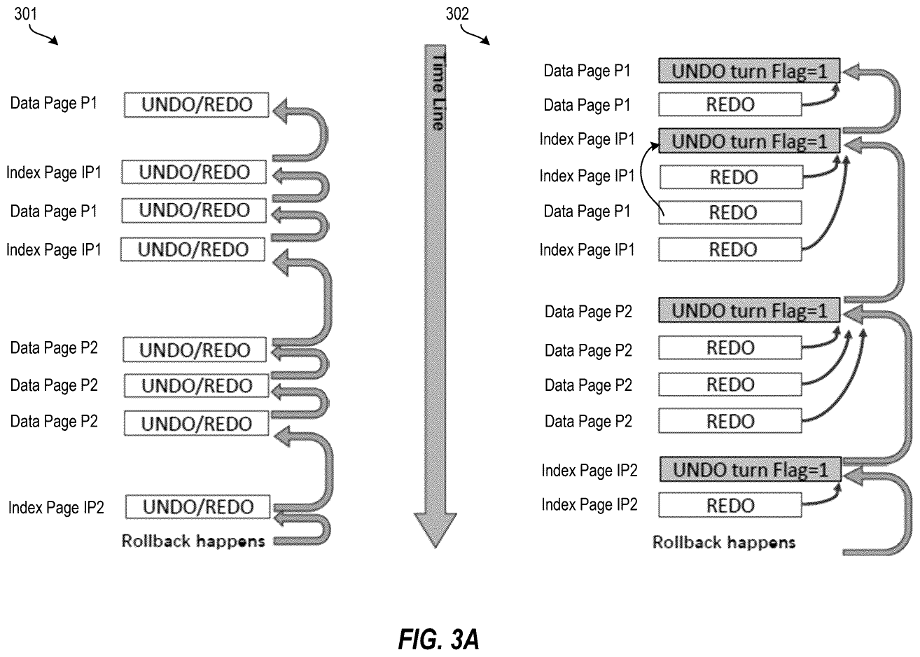

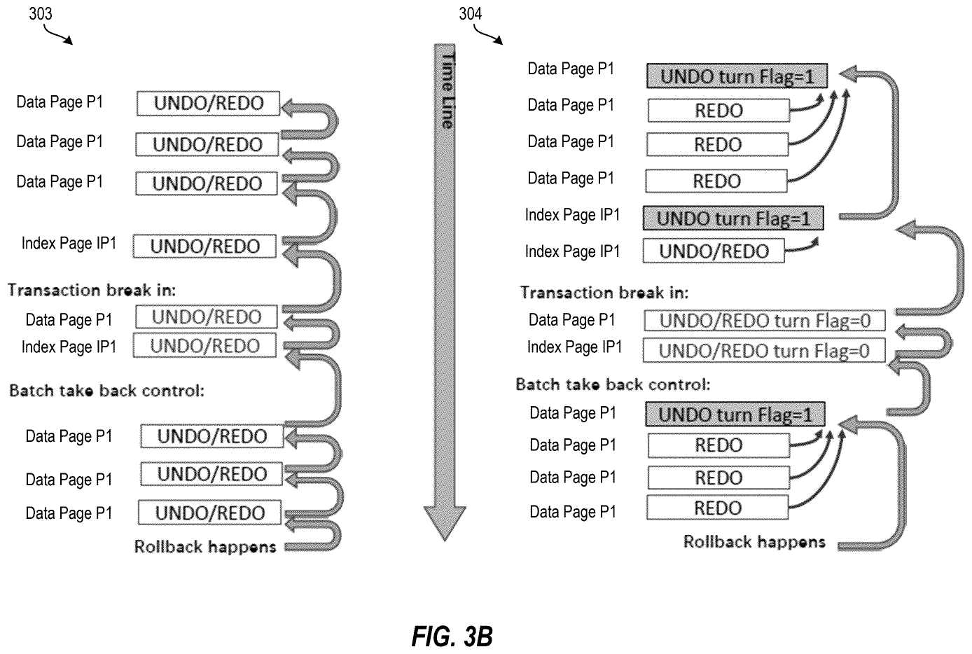

FIG. 3A illustrates a diagram comparing an existing rollback approach 301 to the rollback approach 302 described herein according to one or more embodiments. The comparison in FIG. 3A applies to both PLL and RLL. Under the existing rollback approach 301, eight logs are red and then rolled back one-by-one when a rollback process occurs. Under the rollback approach 302, the four UNDO logs are read and externalized for the four data/index pages. When a related page's fast_backout flag is ON, the database batch job engine 150 writes the log with the REDO portion.

FIG. 3B illustrates a diagram comparing an existing rollback approach 303 to the rollback approach 304 described herein according to one or more embodiments. The comparison in FIG. 3A applies to RLL. In this example, the fast_backout flag is ON when a candidate batch job is taking control for the related page. When a transaction breaks in, the database batch job engine 150 turns the fast_backout flag OFF.

The rollback technique described in the various embodiments offers significant advantages that enhance the functioning of computer systems, particularly those that implement databases or other mechanisms for storing data. One of the technical benefits is the reduction in time for performing the rollback process, which minimizes the duration of data unavailability/outages for related objects. By recording a “beginning image” of the database page before any changes are made, one or more embodiments can revert the database to its original state in a single operation if an error occurs, rather than undoing each change individually. This approach not only speeds up the recovery process but also reduces the processing resources used for performing rollback, thereby improving overall computer system performance.

Another advantage of the rollback technique is its ability to maintain high availability of database management systems. By optimizing the rollback process, one or more embodiments ensures that data remains accessible and consistent, even in the event of errors or failures during batch job execution. This is particularly useful in environments where large-scale data operations are common, as it prevents extended periods of data unavailability that can disrupt business operations and affect user experience. This improvement in efficiency in handling rollbacks also contributes to improved system throughput, as it allows other transactions to proceed without being delayed by lengthy recovery processes.

The rollback technique described herein further enhances system functionality by providing a tailored approach to managing data modifications based on locking granularity. By differentiating between page level locking row level locking, one or more embodiments can apply an appropriate rollback strategy for the specific scenario, ensuring that the rollback process is both efficient and effective. This flexibility allows the system to adapt to various transaction patterns and data structures, optimizing performance across different use cases. Additionally, one or more embodiments' ability to dynamically adjust the involvement of objects in the fast recovery process ensures that only those batch jobs that meet certain criteria are selected, further streamlining operations and reducing unnecessary overhead.

Consider an example in which a batch touches 10,000 pages and performs an INSERT operation on each page up to 255 records and then updates all of them. Using an existing rollback approach, the log amount that is read is 255×2×10,000=51,000,000. Using the rollback approach described herein, the log amount is 10,000, representing a substantial reduction in the number of operations performed during the rollback, thereby saving significant processing resources.

Overall, the rollback technique described herein provides a robust solution for managing data integrity and system performance in database environments. By leveraging innovative strategies for recording and reverting changes, one or more embodiments addresses common technical challenges associated with existing rollback approaches, offering a more efficient and reliable approach to data recovery. These improvements not only enhance the functionality of database systems but also contribute to the broader goal of maintaining high availability and performance in modern computing environments.

While the foregoing is directed to embodiments of the present disclosure, other and further embodiments of the present disclosure may be devised without departing from the basic scope thereof, and the scope thereof is determined by the claims that follow.

1. A computer-implemented method comprising:
receiving a batch job to be executed on a database of a computer system;
recording a beginning image of the database prior to executing the batch job;
initiating executing the batch job; and
responsive to encountering an error while executing the batch job, performing a rollback operation that reverts the database to a state at a time the beginning image was recorded without undoing individual tasks of the batch job on a task-by-task basis.

2. The computer-implemented method of claim 1, wherein the beginning image is an image of a page of the database.

3. The computer-implemented method of claim 1, wherein recording the beginning image of the database is triggered responsive to a page of the database being latched.

4. The computer-implemented method of claim 1, wherein the rollback reverts the database to a state at a time the beginning image of the database was recorded without undoing individual tasks of the batch job.

5. The computer-implemented method of claim 1, further comprising tracking statistics about the batch job and other batch jobs to determine which batch jobs are suitable for recording the beginning image and initiating the rollback based at least in part on the beginning image.

6. The computer-implemented method of claim 5, wherein the recording the beginning image and the initiating the rollback based at least in part on the beginning image are disabled based on a number of consecutive lock requests against a same page of the database exceeding a threshold as determined by the statistics about the batch job and other batch jobs.

7. The computer-implemented method of claim 1, further comprising, responsive to not encountering an error while executing the batch job, continuing to execute the batch job until the batch job is completed.

8. The computer-implemented method of claim 7, further comprising, subsequent to completing the batch job, deleting the beginning image of the database.

9. A computer system comprising:
a processor set;
one or more computer-readable storage media; and
program instructions stored on the one or more computer-readable storage media to cause the processor set to perform operations comprising:
receiving a batch job to be executed on a database of a computer system;
recording a beginning image of the database prior to executing the batch job;
initiating executing the batch job; and
responsive to encountering an error while executing the batch job, performing a rollback operation that reverts the database to a state at a time the beginning image was recorded without undoing individual tasks of the batch job on a task-by-task basis.

10. The computer system of claim 9, wherein the beginning image is an image of a page of the database.

11. The computer system of claim 9, wherein recording the beginning image of the database is triggered responsive to a page of the database being latched.

12. The computer system of claim 9, wherein the rollback reverts the database to a state at a time the beginning image of the database was recorded without undoing individual tasks of the batch job.

13. The computer system of claim 9, the operations further comprising tracking statistics about the batch job and other batch jobs to determine which batch jobs are suitable for recording the beginning image and initiating the rollback based at least in part on the beginning image.

14. The computer system of claim 13, wherein the recording the beginning image and the initiating the rollback based at least in part on the beginning image are disabled based on a number of consecutive lock requests against a same page of the database exceeding a threshold as determined by the statistics about the batch job and other batch jobs.

15. The computer system of claim 9, the operations further comprising, responsive to not encountering an error while executing the batch job, continuing to execute the batch job until the batch job is completed.

16. The computer system of claim 15, the operations further comprising, subsequent to completing the batch job, deleting the beginning image of the database.

17. A computer program product comprising:
one or more computer-readable storage media; and
program instructions stored on the one or more computer-readable storage media to perform operations comprising:
receiving a batch job to be executed on a database of a computer system;
recording a beginning image of the database prior to executing the batch job;
initiating executing the batch job; and
responsive to encountering an error while executing the batch job, performing a rollback operation that reverts the database to a state at a time the beginning image was recorded without undoing individual tasks of the batch job on a task-by-task basis.

18. The computer program product of claim 17, wherein the beginning image is an image of a page of the database.

19. The computer program product of claim 17, wherein recording the beginning image of the database is triggered responsive to a page of the database being latched.

20. The computer program product of claim 17, wherein the rollback reverts the database to a state at a time the beginning image of the database was recorded without undoing individual tasks of the batch job.
